(19) United States
(12) Patent Application Publication
(10) Pub. No.: US 2019/0100282 A1
(43) Pub. Date: Apr. 4, 2019

(54) ARTICLE IN MOTION COMPRISING HYDROPHOBICALLY-COATED REGION

(71) Applicant: SILCOTEK CORP., Bellefonte, PA (US)

(72) Inventors: Pierre A. LECLAIR, Spring Mills, PA (US); David A. SMITH, Bellefonte, PA (US); Geoffrey K. WHITE, Cranberry Township, PA (US); Travis HALL, Snow Shoe, PA (US)

(21) Appl. No.: 16/148,567

(22) Filed: Oct. 1, 2018

Related U.S. Application Data
(60) Provisional application No. 62/566,753, filed on Oct. 2, 2017.

(51) Int. Cl. B63B 1/34; A01K 95/00; A01K 85/00; B64G 1/10; B64C 1/00; B64C 39/02; G01P 5/165; F42B 12/80

(52) U.S. Cl. CPC B63B 1/34; A01K 95/00; A01K 85/005; F42B 12/80; B64C 1/0009; B64C 39/024; G01P 5/165; B64G 1/10

(57) ABSTRACT

Articles having a hydrophobically-coated region and processes of using such articles are disclosed. The article includes a substrate material and a hydrophobically-coated region on the substrate material, the hydrophobically-coated region being contacted or configured for contact with a fluid. The hydrophobically-coated region is configured to repulse the fluid from the article while the article is moving through the fluid. The process includes using the article by moving the article through the fluid wherein the hydrophobically-coated region repulses the fluid from the article.

### PRIORITY

The present application is a non-provisional patent application claiming priority and benefit of U.S. Provisional Patent Application No. 62/566,753, filed Oct. 2, 2017, and entitled “METHOD OF USING THERMAL CHEMICAL VAPOR DEPOSITION COATED,” the entirety of which is incorporated by reference.

### FIELD OF THE INVENTION

The present invention relates to articles having a hydrophobically-coated region and processes of using such articles. More particularly, the present invention relates to such article and processes configured for and/or actually moving through a fluid.

### BACKGROUND OF THE INVENTION

When most objects contact a fluid, the objects decelerate at a substantial rate. Such a deceleration can drastically impact the structural integrity of the object. For example, when copper-jacketed bullets contact water, they are known to fragment.

Substantial efforts have been employed to decrease such fragmentation. For example, U.S. Pat. No. 8,082,851, which is hereby incorporated by reference in its entirety, describes use of complicated mathematic relationships to design a bullet that can go into water. Such specific calculations require precisely machining or otherwise manufacturing, which can be cost-prohibitive and/or extremely complex.

The shape and velocity of projectiles has been studied to reduce drag associated with projectiles moving from air to a liquid. For example, in SELF-DETERMINED SHAPES AND VELOCITIES OF GIANT NEAR-ZERO DRAG GAS CAVITIES, from Science Advances, 8 Sep. 2017 (http://advances.sciencemag.org/content/3/9/e1701558.full), which is incorporated by reference in its entirety, superhydrophobic spheres are described to have a streamlined gas cavity produced by contacting the projectile with the water. Those skilled in the art understand that the term superhydrophobic describes having a water contact angle of greater than 150 degrees.

The Science Advances publication describes specific conditions for the liquid and does not describe the superhydrophobic spheres (other than to identify it as being steel). The Science Advances publication does not suggest whether the superhydrophobic spheres are resistant to water over a period of time, whether they are resistant to thermal oxidation, and/or whether they degrade in any other manner.

Selection of material can be limited for certain processes. For example, thermal chemical vapor deposition is limited to materials that can withstand the temperatures of the process without degrading and without contaminating other materials processed at the same time. Copper, bronze, and brass had previously been considered incompatible for such processes.

Articles having a hydrophobically-coated region and processes of using such articles that show one or more improvements in comparison to the prior art would be desirable in the art.

### BRIEF DESCRIPTION OF THE INVENTION

In an embodiment, an article in motion includes a substrate material and a hydrophobically-coated region on the substrate material, the hydrophobically-coated region being contacted with a fluid. The hydrophobically-coated region repulses the fluid from the article while the article is moving through the fluid.

In another embodiment, an article includes a substrate material and a hydrophobically-coated region on the substrate material, the hydrophobically-coated region being contacted with a fluid. The hydrophobically-coated region is configured to repulse the fluid from the article while the article is moving through the fluid.

In another embodiment, a process of using an article includes providing the article, the article having a substrate material and a hydrophobically-coated region on the substrate material, the hydrophobically-coated region being contacted with a fluid, and moving the article through the fluid wherein the hydrophobically-coated region repulses the fluid from the article.

Other features and advantages of the present invention will be apparent from the following more detailed description, taken in conjunction with the accompanying drawings which illustrate, by way of example, the principles of the invention.

### BRIEF DESCRIPTION OF THE DRAWINGS

FIG. 1 is a schematic perspective view of an article, specifically a bullet, according to an embodiment of the disclosure.

FIG. 2 is a schematic perspective view of an article, specifically a torpedo, according to an embodiment of the disclosure.

FIG. 3 is a schematic perspective view of an article, specifically an arrowhead, according to an embodiment of the disclosure.

FIG. 4 is a schematic perspective view of an article, specifically a spearhead, according to an embodiment of the disclosure.

FIG. 5 is a pictorial showing a variety of embodiments of aquatic-related devices, according to embodiments of the disclosure, specifically, a boat keel, a towable, a boat pitot, and a fishing weight.

FIG. 6 is a schematic perspective view of an article, specifically an aerospace device, according to an embodiment of the disclosure.

Wherever possible, the same reference numbers will be used throughout the drawings to represent the same parts.

### DETAILED DESCRIPTION OF THE INVENTION

Provided are articles having a hydrophobically-coated region and processes of using such articles. Embodiments of the present disclosure, for example, in comparison to concepts failing to include one or more of the features disclosed herein, reduce or eliminate structural effects resulting from entering denser fluids, permit reduced drag, permit simpler design to achieve reduced fragmentation of bullets, permit increased mobility and/or efficiency, permit formation of a gas cavity at a lower temperature (for example, less than 300 degrees C., less than 200 degrees C., less than 100 degrees C., at ambient temperature, or any suitable combination, sub-combination, range, or sub-range therein), or a combination thereof.

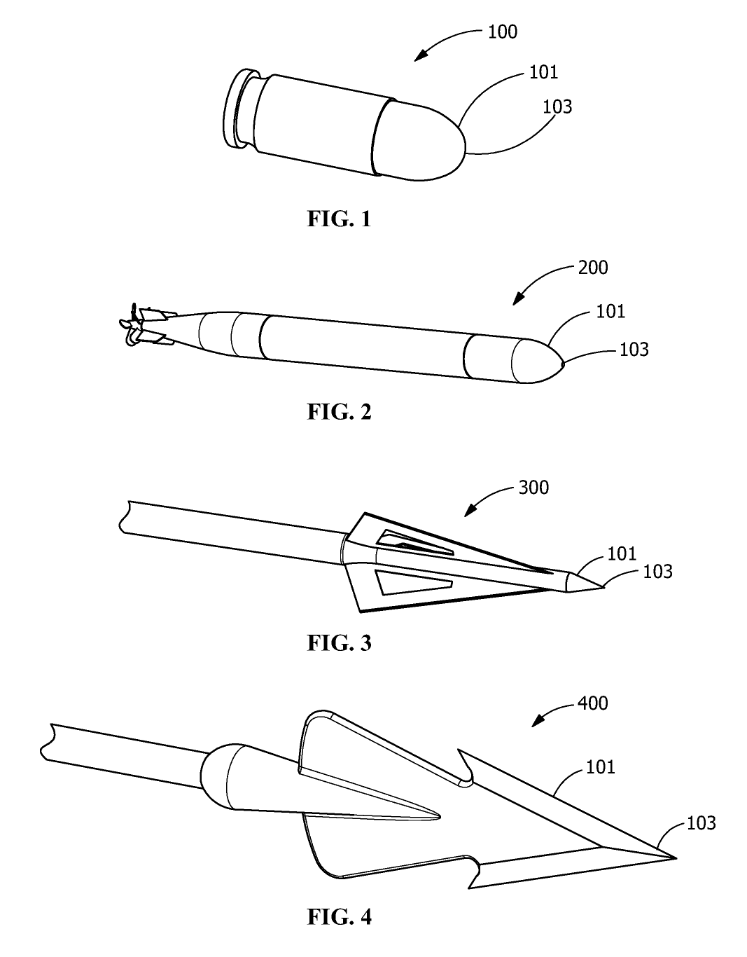

Referring to FIGS. 1-6, according to various embodiments, an article configured for motion through a fluid is disclosed. The article is a bullet 100 (see FIG. 1), a torpedo 200 (see FIG. 2), an arrowhead 300 (see FIG. 3), a spearhead (see FIG. 4), an aquatic-related article (for example, as shown in FIG. 4, a boat keel 500, a towable 502, a boat pitot 504, a fishing weight 506, or any other suitable naval-related device), an aerospace device 600 (see FIG. 6), and/or any other suitable device that is used in contact with a fluid, such as, a gas or liquid. In a further embodiment, the article is used in contact with multiple fluids, such as a lower-density fluid initially (such as, air or the upper atmosphere) and a higher density fluid (such as, water or the lower atmosphere).

The article includes a substrate material 101 and a hydrophobically-coated region 103 on the substrate material 101. The hydrophobically-coated region 103 is positioned to be contacted with the fluid, and is capable of being limited to such regions or on the entirety of the substrate material 101. The hydrophobically-coated region 103 repulses the fluid from the article while the article is moving through the fluid.

In one embodiment, the hydrophobically-coated region 103 includes a fluoro-containing thermal chemical vapor deposition, for example, produced by introducing of a fluorine-silicon-carbon-containing precursor within a pressure range and a temperature range for a duration of time during the one or more steps. Suitable fluorine-silicon-carbon-containing precursors for imparting the constituents include, but are not limited to, an organofluorotrialkoxysilane, an organofluorosilylhydride, an organofluoro silyl, a fluorinated alkoxysilane, a fluoroalkylsilane, a fluorosilane, or a combination thereof. Additionally or alternatively, specific embodiments of the fluorine-silicon-carbon-containing precursors for imparting the constituents include, but are not limited to, tridecafluoro 1,1,2,2-tetrahydrooctyl silane; (tridecafluoro-1,1,2,2-tetrahydrooctyl) triethoxysilane (also known as triethoxy (1H,1H,2H,2H-perfluoro-1-octyl) silane, triethoxy (3,3,4,4,5,5,6,6,7,7,8,8,8-tridecafluoro-1-octyl) silane, 1H,1H,2H,2H-perfluorooctyltriethoxysilane, or silane, triethoxy (3,3,4,4,5,5,6,6,7,7,8,8,8-tridecafluorooctyl)-); (perfluorohexylethyl) triethoxysilane; silane, (3,3,4,4,5,5,6,6,7,7,8,8,9,9,10,10,10-heptadecafluorodecyl) trimethoxy-; 1H,1H,2H,2H-perfluorodecyl trichlorosilane; 1H,1H,1H,2H-perfluorodecyl trimethoxysilane; 1H,1H,2H,2H-perfluorodecyltriethoxysilane; 1H,1H,2H,2H-perfluorooctyltrimethoxysilane; or a combination thereof.

In one embodiment, the pressure range for the introducing of the fluorine-silicon-carbon-containing precursor is between 0.01 psia and 200 psia, between 1.0 psia and 100 psia, between 5 psia and 40 psia, between 20 psia and 25 psia, greater than 25 psia, greater than 20 psia, less than 20 psia, less than 15 psia, 1.0 psia, 5 psia, 20 psia, 23 psia, 25 psia, 40 psia, 100 psia, 200 psia, or any suitable combination, sub-combination, range, or sub-range therein.

In one embodiment, the temperature range for the introducing of the fluorine-silicon-carbon-containing precursor is between 100° C. and 700° C., between 100° C. and 450° C., between 100° C. and 300° C., between 200° C. and 500° C., between 300° C. and 600° C., between 450° C. and 700° C., 700° C., 450° C., 100° C., between 200° C. and 600° C., between 300° C. and 600° C., between 400° C. and 500° C., 300° C., 400° C., 500° C., 600° C., or any suitable combination, sub-combination, range, or sub-range thereof.

In one embodiment, the duration of time for the introducing of the fluorine-silicon-carbon-containing precursor is at least 10 minutes, at least 1 hour, at least 2 hours, at least 3 hours, at least 4 hours, at least 5 hours, at least 7 hours, at least 10 hours, between 10 minutes and 24 hours, between 1 hour and 10 hours, between 1 hour and 5 hours, between 1 hour and 4 hours, between 2 hours and 10 hours, between 4 hours and 6 hours, between 4 hours and 8 hours, between 4 hours and 10 hours, between 6 hours and 8 hours, less than 10 hours, less than 8 hours, less than 6 hours, less than 4 hours, or any suitable combination, sub-combination, range, or sub-range therein.

The one or more steps of introducing of the fluorine-silicon-carbon-containing precursor includes one cycle, two cycles, three cycles, four cycles, or more than four cycles preceded by or followed by other steps, such as, heating steps and/or oxidation steps that are concurrent or sequential. For example, in one embodiment, the surface treatment includes an oxidation step prior to the introducing of the fluorine-silicon-carbon-containing precursor. The oxidation step(s) includes exposure to any suitable chemical species capable of donating a reactive oxygen species into the coating under predetermined oxidation conditions.

An oxidation step is capable of being achieved by exposure to water (alone, with zero air, or with an inert gas), oxygen (for example, at a concentration, by weight, of at least 50%), air (for example, alone, not alone, and/or as zero air), nitrous oxide, ozone, peroxide, or a combination thereof. As used herein, the term “zero air” refers to atmospheric air having less than 0.1 ppm total hydrocarbons. The term “air” generally refers to a gaseous fluid, by weight, of mostly nitrogen, with the oxygen being the second highest concentration species within. For example, in one embodiment, the nitrogen in the oxidation step is present at a concentration, by weight, of at least 70% (for example, between 75% and 76%) and oxygen is present at a concentration, by weight, of at least 20% (for example, between 23% and 24%).

In one embodiment, the oxidation step is with water as an oxidizing agent (for example, within a temperature range of between 25° C. and 600° C., a temperature range of between 300° C. and 600° C., or at a temperature of 450° C.). In one embodiment, the oxidation step is with air and water (for example, within a temperature range of between 100° C. and 600° C., a temperature range of 300° C. to 600° C., or at a temperature of 450° C.). In one embodiment, the oxidation step is only with air (for example, within a temperature range of between 100° C. and 600° C., a temperature range of between 300° C. and 600° C., or at a temperature of 450° C.). In one embodiment, the oxidation step is with nitrous oxide (N₂O). Specifically, N₂O is applied under heat (for example, about 450° C.) with a pressure of substantially pure N₂O in a vessel with carbosilane-coated samples.

Other suitable steps to precede or follow the introducing of the fluorine-silicon-carbon-containing gas include purging, cleaning, and/or heating an enclosed chamber and/or vessel. In one embodiment, the purging evacuates or substantially evacuates gas(es) from the enclosed chamber and/or the vessel by selectively applying a purge gas. Suitable purge gases are nitrogen, helium, argon, or any other inert gas. The purging is in one purge cycle, two purge cycles, three purge cycles, more than three purge cycles, or any suitable number of purge cycles that permits the enclosed chamber and/or the vessel to be a chemically inert environment.

In one embodiment, the cleaning removes undesirable materials from the substrate material 103. The cleaning includes any suitable technique for removing materials that may volatilize in the higher temperatures of the enclosed chamber and/or vessel or that may inhibit the ability for the surface treatment to impart the fluorine, silicon, and carbon.

In one embodiment, the heating is from a lower temperature of the fluorine-silicon-carbon-containing precursor to a higher temperature of the fluorine-silicon-carbon-containing precursor. Depending upon the species of the fluorine-silicon-carbon-containing precursor utilized, suitable temperatures include, but are not limited to, less than 30° C., less than 60° C., less than 100° C., less than 150° C., less than 200° C., less than 250° C., less than 300° C., less than 350° C., less than 400° C., less than 440° C., less than 450° C., between 100° C. and 300° C., between 125° C. and 275° C., between 200° C. and 300° C., between 230° C. and 270° C., or any suitable combination, sub-combination, range, or sub-range therein.

The hydrophobically-coated region 103 has a water-contact angle indicative of being hydrophobic. For example, the water contact angle (deionized water) of 356 cast aluminum is 96 degrees, the water contact angle (deionized water) of 6061 aluminum is 99 degrees, and the water contact angle (deionized water) of 304 stainless steel is 21 degrees. Coating the respective materials according the present disclosure results in the hydrophobically-coated region 103 being between 100 and 110 degrees for 356 cast aluminum, being between 130 and 140 degrees for 6061 aluminum, and being between 135 and 145 for 304 stainless steel. In other embodiments, the contact angle is within the range of between 115° and 170°, such as, between 115° and 140°, between 118° and 135°, between 120° and 121° (for example, on 304 stainless steel), between 125° and 126° (for example, on 316 stainless steel), or any suitable combination, sub-combination, range, or sub-range therein. Additionally or alternatively, in one embodiment, a hexadecane contact angle is within the range of between 65° and 110°, such as, between 65° and 90°, between 70° and 85°, between 77° and 78° (for example, on 304 stainless steel), between 75° and 76° (for example, on 316 stainless steel), or any suitable combination, sub-combination, range, or sub-range therein.

The substrate material 101 is any component compatible with thermal chemical vapor deposition. For example, the substrate material 101 is not bronze, which is incompatible. However, the substrate material 101 is capable of being brass and/or copper (for example, greater than 5%, by weight, and/or at a concentration of greater than 50%, by weight), which were previously considered incompatible. Other suitable substrate materials 101 include, but are not limited to, zinc, galvanized steel, chrome, copper-based alloy, nickel-based alloy, steel, stainless steel, and an aluminum alloy. Additionally or alternatively, suitable species of the substrate materials 101 include, but are not limited to, super duplex steel, carbon steel, cast iron, or Monel® alloys.

Referring to FIG. 1, in the embodiments with article being the bullet 100, the bullet 100 is capable of travelling into water for a greater distance and/or is more resistant to structural effects of contacting the water than a comparative bullet having the same design and materials but without the hydrophobically-coated region 103. Similarly, the article is capable of being used as a musket ball, shot, on penetrative tips, on bleads, on jackets (for example, copper jackets) or other ammunition or ammunition-related features.

Referring to FIG. 2, in the embodiments with the article being the torpedo 200 (or surface to water missile, projectile, depth charge, or other naval-defense measure), in comparison to a comparative torpedo having the same design and materials but without the hydrophobically-coated region 103, the torpedo 200 is capable of travelling into water for a greater distance, is more resistant to structural effects of contacting the water, has reduced drag, has increased accuracy/mobility, or a combination thereof.

Referring to FIGS. 3-4, in the embodiments of the arrowhead 300 and/or the spearhead 400 (or other mechanically-powered or hand-powered projectile), the article is capable of travelling into water for a greater distance and/or is more resistant to structural effects of contacting the water than a comparative article having the same design and materials but without the hydrophobically-coated region 103. Additionally or alternatively, in one embodiment, the hydrophobically-coated region 103 permits the aiming to be more precise.

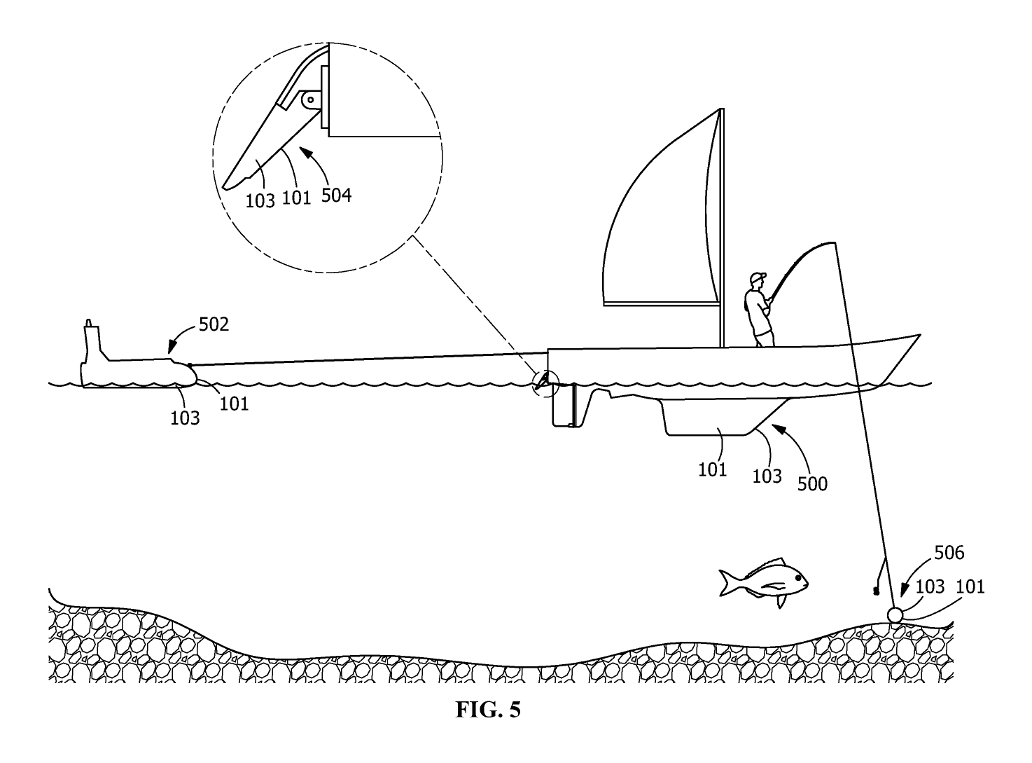

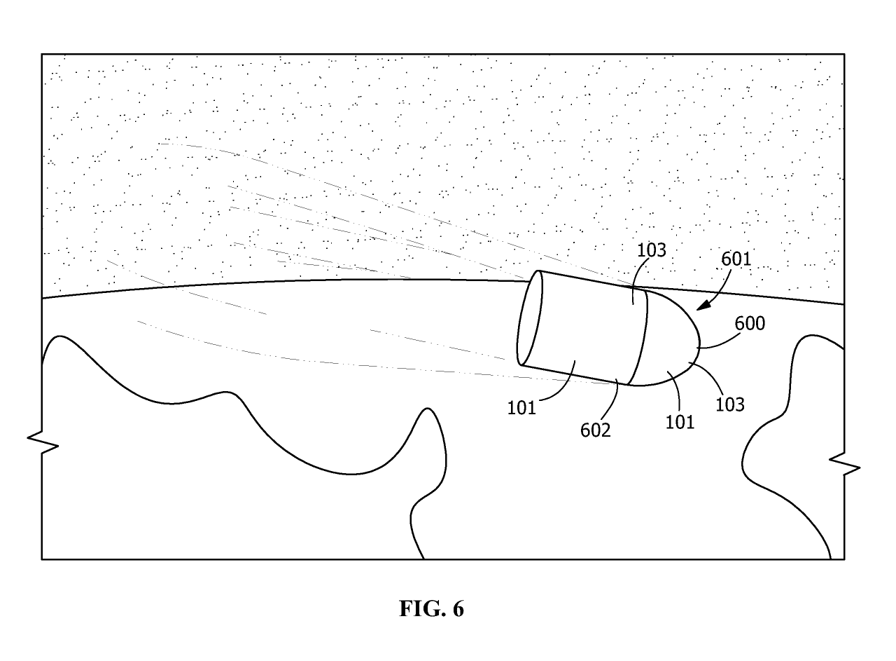

Referring to FIG. 5, the article is capable of being used in a variety of aquatic-related devices. Although FIG. 5, shows the boat keel 500, the towable 502, the boat pitot 504, and the fishing weight 506, other suitable aquatic and/or naval-related devices are capable of being coated with the hydrophobically-coated region 103 (such as rudders, propellers, anchors, tow-cables, fittings, sensors, water-skis, buoys, autonomous underwater vehicles, underwater unmanned vehicles, and/or underwater inspection robots). In one embodiment with the fishing weight 506, the fishing weight 506 moving through the fluid is used to produces bubbles, which attract fish.

Referring to FIG. 6, in embodiments, where the article is an aerospace device 600, in comparison to a comparative aerospace device having the same design and materials but without the hydrophobically-coated region 103, the aerospace device 600 is more resistant to structural effects of contacting the denser fluid (for example, atmosphere), has reduced drag, has increased accuracy/mobility, has decreased heat (for example, from re-entry), or a combination thereof. Suitable embodiments of the aerospace device 600 include, but are not limited to, a plane, a satellite, a space craft, a drone, an exploratory system, air-launched autonomous micro observers, a missile (for example an intercontinental ballistic missile), an interplanetary module, or a combination thereof. In one embodiment, the aerospace device 600 includes a tip 600 positioned to be directly contacted by the denser fluid (for example, the atmosphere during re-entry) and a non-tip region 602 positioned to be tangentially contacted by the denser fluid.

While the invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In addition, all numerical values identified in the detailed description shall be interpreted as though the precise and approximate values are both expressly identified.

What is claimed is:

1. An article in motion, comprising:
a substrate material; and
a hydrophobically-coated region on the substrate material, the hydrophobically-coated region being contacted with a fluid;
wherein the hydrophobically-coated region repulses the fluid from the article while the article is moving through the fluid.

2. The article of claim 1, wherein the hydrophobically-coated region includes a fluoro-containing thermal chemical vapor deposition.

3. The article of claim 1, wherein the substrate material is selected from the group consisting of copper, brass, zinc, galvanized steel, chrome, copper-based alloy, nickel-based alloy, steel, stainless steel, and an aluminum alloy.

4. The article of claim 1, wherein the substrate material is super duplex steel, carbon steel, cast iron, or Monel® alloys.

5. The article of claim 1, wherein the substrate material includes copper at concentration greater than 5%, by weight.

6. The article of claim 1, wherein the moving of the article in the fluid is preceded by the article entering the fluid from a lower density fluid.

7. The article of claim 1, wherein the article is a bullet.

8. The article of claim 1, wherein the article is a torpedo.

9. The article of claim 1, wherein the article is an arrowhead or spearhead.

10. The article of claim 1, wherein the article is selected from the group of a boat keel, a towable, a boat pitot, and a fishing weight.

11. The article of claim 10, wherein the article is the fishing weight and the moving through the fluid produces bubbles that attract fish.

12. The article of claim 1, wherein the article is an aerospace device.

13. The article of claim 12, wherein the aerospace device is a plane.

14. The article of claim 12, wherein the aerospace device is a satellite.

15. The article of claim 12, wherein the aerospace device is a space craft.

16. The article of claim 12, wherein the aerospace device is a drone.

17. The article of claim 12, wherein the aerospace device is a missile.

18. The article of claim 12, wherein the aerospace device is an interplanetary module.

19. An article, comprising:
a substrate material; and
a hydrophobically-coated region on the substrate material, the hydrophobically-coated region being contacted with a fluid;
wherein the hydrophobically-coated region is configured to repulse the fluid from the article while the article is moving through the fluid.

20. A process of using an article, the process comprising:
providing the article, the article having a substrate material and a hydrophobically-coated region on the substrate material, the hydrophobically-coated region being contacted with a fluid; and
moving the article through the fluid wherein the hydrophobically-coated region repulses the fluid from the article.
